(19) United States
(12) Patent Application Publication
(10) Pub. No.: US 2023/0292808 A1
(43) Pub. Date: Sep. 21, 2023

(54) EASILY REPAIRABLE MAIN WASH BASKET FOR WASHING CANNABIS

(71) Applicant: John C. Digertt, Inc., Durham, CT (US)

(72) Inventors: John A. Digertt, Durham, CT (US); Brian Pracon, Berlin, CT (US)

(73) Assignee: John C. Digertt, Inc., Durham, CT (US)

(21) Appl. No.: 18/186,784

(22) Filed: Mar. 20, 2023

Related U.S. Application Data
(60) Provisional application No. 63/322,177, filed on Mar. 21, 2022.

(51) Int. Cl. A23N 12/02; A47J 43/24

(52) U.S. Cl. CPC A23N 12/02; A47J 43/24

(57) ABSTRACT

The improved wash basket of the present invention provides a modular design and configuration to enable the repair of selective component of the wash basket by individually separating them from the cylindrical frame. This reduces downtime of the wash basket and facilitates repair of the wash basket so it can be used again in a main washing vessel.

### CROSS REFERENCE TO RELATED APPLICATION

This patent document claims priority to earlier filed U.S. Provisional Patent Application Ser. No. 63/322,177, filed Mar. 21, 2022, the entire contents of which are incorporated herein by reference.

### BACKGROUND OF THE INVENTION

The invention related generally to extraction of cannabinoids from cannabis plant material to make hash and other products from the cannabis plant. The invention is particularly related to the collection of trichomes in an efficient and cost-effective manner.

It is well known to extract cannabinoids from cannabis plant material with the assistance of chemical solvents. However, there is serious concern regarding the health issues associated with the use of such chemical solvents for cannabinoid extraction. Besides the increased risk of an explosion in the presence of hazardous materials, the final product could contain a harmful amount of residual solvents. Many government regulations are in place that set cutoff limits for the maximum amount of solvent that can be present in a cannabis product.

Therefore, health-conscious consumers and those using cannabis for medical purposes have turned to solvent-free cannabis extracts to avoid consuming chemical toxins during inhalation, ingesting or consumption. Solvent-free extracts provide customers with a cleaner alternative to solvent-based extracts, such as BHO or CO2 oil.

Cold or ice water extraction of cannabinoids from cannabis plant material is well known in the art for solvent free extraction to address these concerns. It is well known to use ice, water, agitation and filtration to separate the trichomes present on the plant from the raw cannabis material. This process works because the cannabinoids are not water soluble. Moreover, frozen cannabis product is preferably used because the resin gland trichomes can break off from the main plant more easily thereby resulting in a better and complete extraction.

One of the first “washing” methods by which hash was extracted without the use of solvents was by hand-rubbing the frozen or cold flower buds and scraping off the sticky trichomes with a knife forming them into a ball. Such a manual method for making solvent free hash is to wash and separate by means of a hand paddle and hand screen. The disadvantages of this method are that it is very inconsistent and very labor intensive. Moreover, replicating the washing and collection process from batch to batch is very difficult to do as well as controlling the temperatures of all vessels. Ice is also needed to keep the product cold and consumes large volumes of ice per batch. Also, the melt rate of ice is difficult to control so, as a result, the temperatures provided by the ice to maintain temperature of the flower buds is very inconsistent. As a result, the end product can be inconsistent in results and in quality.

To address these shortcomings of the washing of a batch of cannabis, it has been known in the industry to use a main wash basket that actuates in a main washing vessel where frozen or cold flower buds are loaded into the wash basket whereby the basket is agitated to thereby cause the trichomes to separate from the main plant. Such known main wash baskets in washing vessels have components that are permanently assembled to each other, such as by resistance welding. For example, in the prior art, a filter mesh panel is resistance welded to a stainless-steel basket frame. Therefore, if the filter mesh panel is damaged, the entire wash basket must be returned for service. This is not desirable due to the high cost to ship an entire wash basket. Also, during this down time, the entire wash basket is unusable merely due to a single filter mesh panel being damaged, thereby causing unnecessary production delays.

In view of the foregoing, there is a demand for a wash basket for a main washing vessel of cannabis processing equipment to be more easily repairable.

There is also a need for a wash basket to be modular in construction for ease of repair and to reduce downtime of the wash basket for use in a main washing vessel.

### SUMMARY OF THE INVENTION

The present invention preserves the advantages of prior art wash baskets for use in washing vessels for solvent-free hash extraction systems and methods and trichome collection devices. In addition, it provides new advantages not found in currently available wash baskets and methods and overcomes many disadvantages of such currently available systems and methods.

The improved wash basket of the present invention provides a modular design and configuration to enable the repair of only one component of the wash basket to reduce downtime and facilitate repair of the wash basket so it can be used again in a main washing vessel.

An object of the present invention is to provide a new and unique wash basket that is more easily repairable than prior art wash baskets.

Another object of the present invention is to provide a wash basket that is modular in construction whereby one component, such as a filter mesh panel, can be easily removed and replaced without sending the entire wash basket in for repair.

Yet another object of the present invention is to provide a cannabis wash basket that includes a rotating center stem with agitator paddles connected thereto.

### BRIEF DESCRIPTION OF THE DRAWING FIGURES

The novel features which are characteristic of the present invention are set forth in the appended claims. However, the invention's preferred embodiments, together with further objects and attendant advantages, will be best understood by reference to the following detailed description taken in connection with the accompanying drawings in which:

FIG. 1 shows a wash basket of the present invention shown in the environment of being loaded or unloaded from a main wash vessel of cannabis processing equipment;

FIG. 2 is top perspective view of the easily repairable wash basket of FIG. 1 shown with top cover installed in place;

FIG. 3 is a front elevational view of wash basket of FIG. 1;

FIG. 4 is a top front perspective view of the wash basket of FIG. 1 with top cover removed for illustration purposes;

FIG. 5 is a perspective view of the top cover of the wash basket of FIG. 1;

FIG. 6 is an interior perspective view of one of the easily repairable side panels of the present invention;

FIG. 7 is an exterior perspective exploded view of the side panel of FIG. 6 showing the lay-up of bezels, gaskets and mesh material;

FIG. 8 is a front elevational view of one of the stainless steel bezels used in the panel of FIG. 6;

FIG. 9 is a perspective view of one of the gaskets used in the panel of FIG. 6;

FIG. 10 is a perspective view of the mesh used in the panel of FIG. 6;

FIG. 11 is an interior view of rotating center stem and agitation paddles attached thereto; and

FIG. 12 is a front elevational view of the wash basket of the present invention showing detail of the agitating paddles attached to the center rotating stem.

### DESCRIPTION OF THE INVENTION

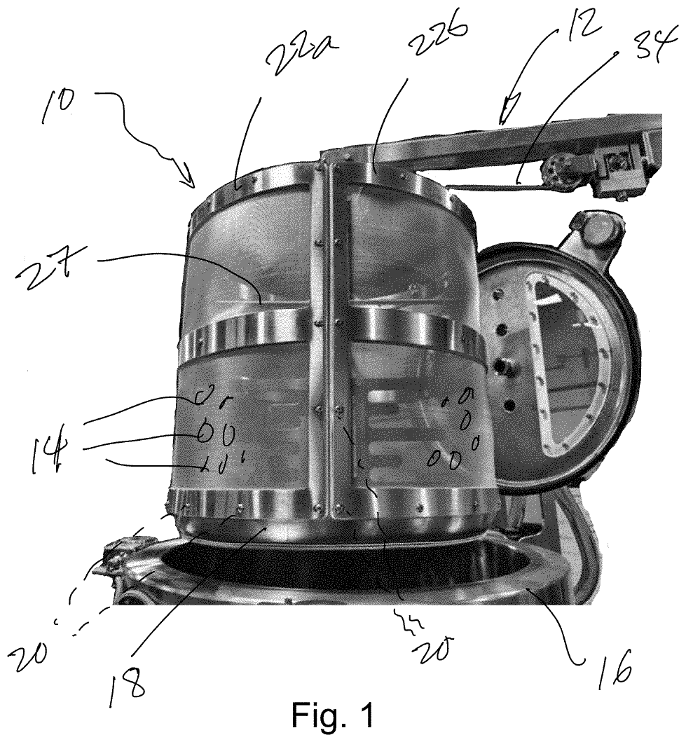

In FIG. 1, the main wash basket 10 of the present invention is shown in the environment of being hung from a winch assembly 12 whereby cannabis product 14, such as frozen cannabis, is loaded into the main wash basket 10 of the present invention. Once loaded with cannabis 14, the wash basket 10 is lowered into a main wash vessel 16. In general, the main wash basket 10 of the present invention preferably includes a generally cylindrical frame 18 with an array of pass-through holes 20. For example, the basket can be 24 inches in diameter and 24 inches high. However, the basket 10 can be sized larger or smaller depending on the application at hand.

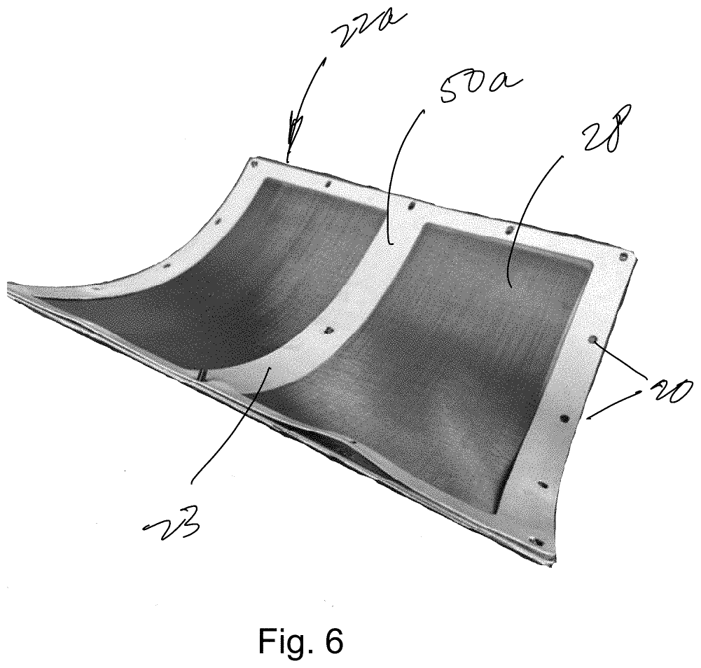

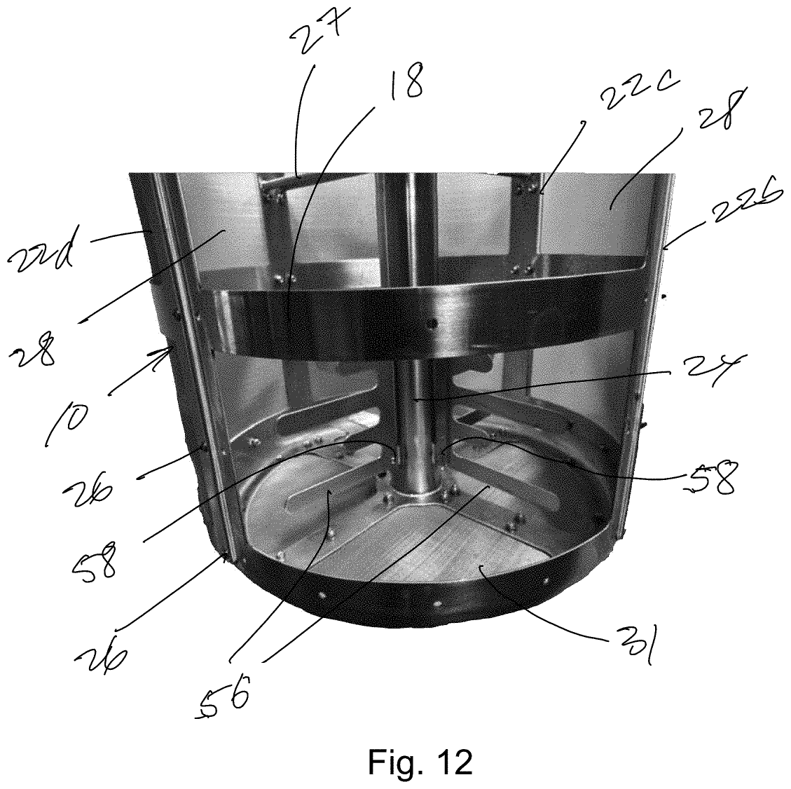

FIG. 12 shows the main wash basket 10 of the present invention with the front panel 22a, one of the four (quarter) panels 22a-d removed for illustration purposes to shown the supporting frame 18 that receives the panels 22a-d. A center stem 24, as seen in FIGS. 1 and 12, is provided as well as reinforcement ribs 27 connected to the frame 18 and the center stem 24. A number of arcuate side panels 22a-d are attached to the frame 18 by bolts 26 and the like and nuts may optionally be used. Other releasable fasteners may be used. In this example, four side arcuate panels 22a-d with filter mesh 28 attached thereto are bolted to the cylindrical frame 18. Preferably, four side panels 22a-d are used about the circumference of the cylinder frame 18 but more or less panels 22 may be used. Also, vertically, the panels 22a-d may be further divided into upper and lower panels (not shown). Details of the lay-up of the panels 22a-d are discussed in detail in FIGS. 6-10 below.

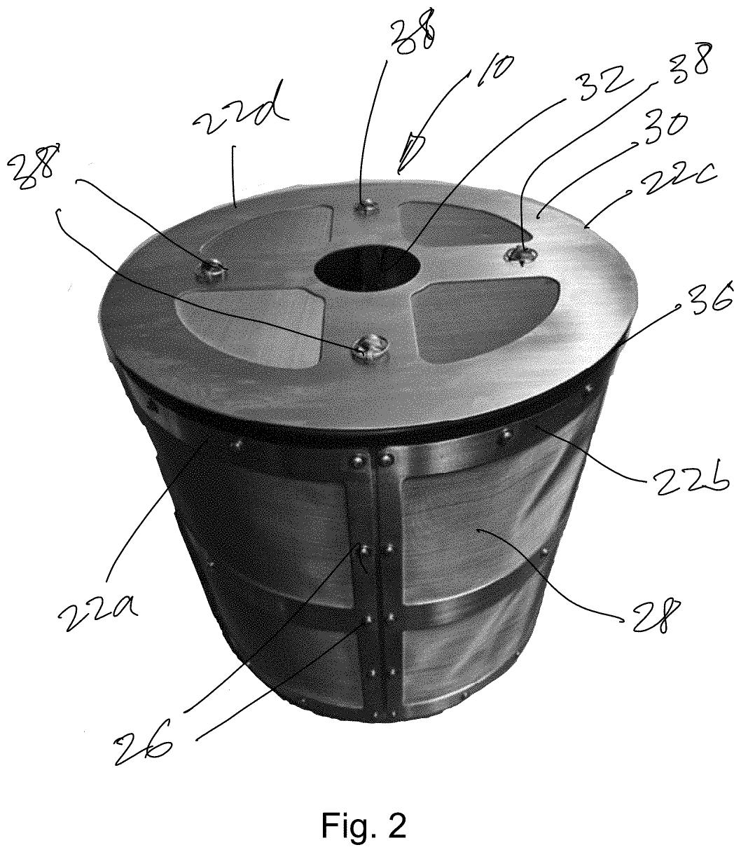

A front top perspective of the main wash basket 10 is shown in FIG. 2 with a top cover 30 in place. A center hole 32 in the top cover 30 is provided for pass-through access of the winch cable 34 and hook (not shown) therethrough.

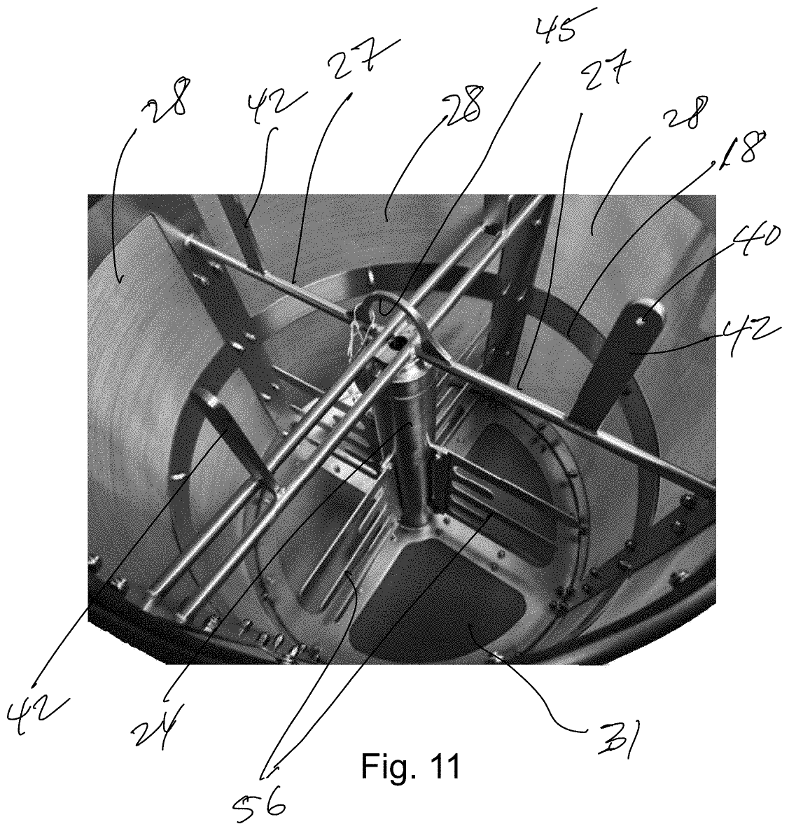

Turning now to FIG. 2, a top perspective view of the easily repairable wash basket 10 of the present invention shows a top cover 30 attached to the wash basket frame 18 in accordance with the present invention with a circumferential gasket 36 residing between a top edge 38 of the frame 18 and the cover 30. The top cover 30 is releasably connected to the frame 18 using releasable fasteners 38 that extend downwardly to engage with apertures 40 through upstanding flanges 42 that emanate upwardly from transverse rods 27 inside the basket 10, as shown in FIG. 11. It should be understood that this preferable connection structure is preferred, any releasable fastening of the top cover 30 to the top edge 38 of the frame 18 is envisioned and within the scope of the present invention.

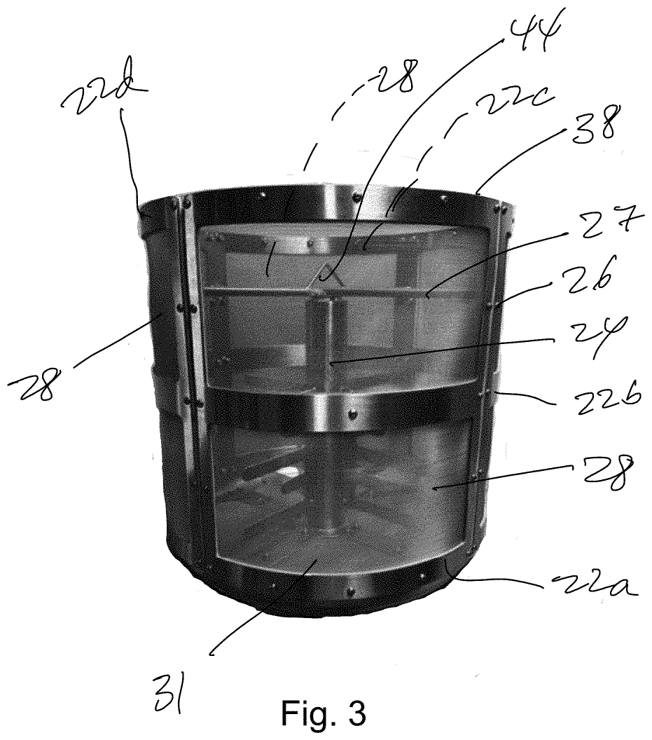

In FIG. 3, a slightly modified main wash basket 10 of the present invention includes the same easily repairable panels 22a-d while including a slightly modified center loop 44 for receiving a winch hook for lifting of the main wash basket 10.

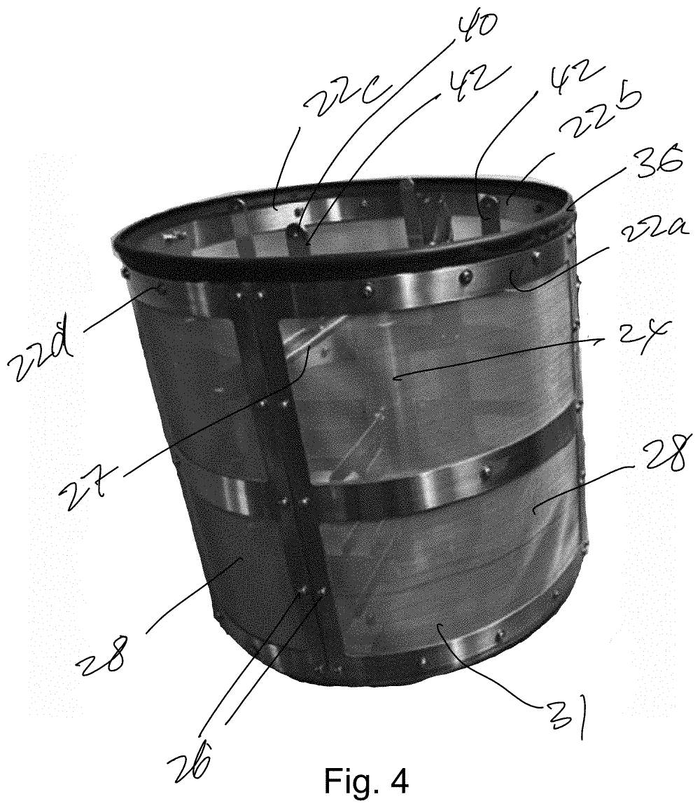

FIG. 4 shows the preferred embodiment of the present invention where the upstanding flanges 42 can be seen with their respective holes 40 at the free ends thereof for receipt of the cover fasteners 38 that are shown in FIG. 2.

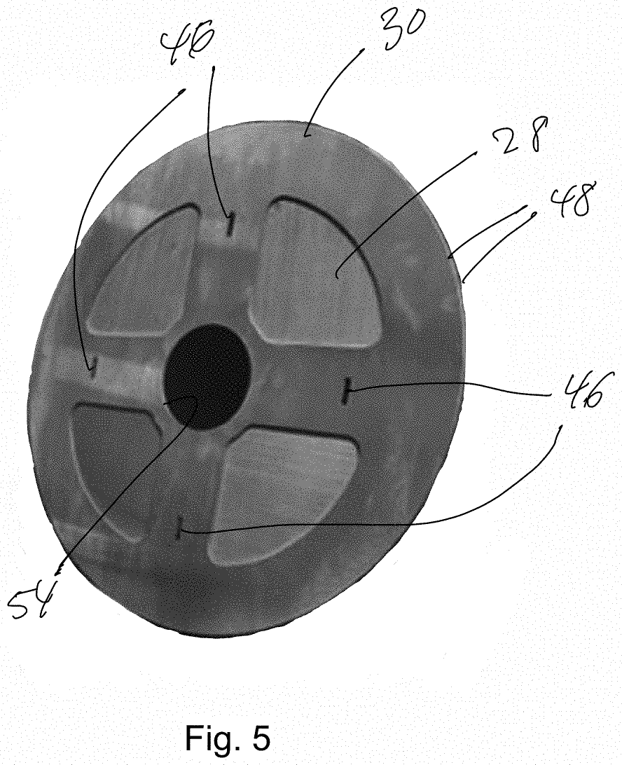

FIG. 5 shows only the top cover 30 with the four pass-through holes 46 that receive the fasteners 38 seen in FIG. 2 so they may engage with the holes 40 of the upstanding flanges 42. The fasteners 38 may be plate-like or rod-like in construction with an engaging hook (not shown) on the free ends thereof for respectively interconnecting to the free ends of the upstanding flanges 42 at their respective holes 40. It should also be noted that the top cover 30 includes mesh material 28 that is captured between two, preferably metal, plates 48 with the mesh 28 captured therebetween. It possible that a single top cover plate 48 is provided with mesh 28 material adhered or otherwise fastened thereto with food safe gasket material 50 residing between the mesh 28 and top cover plate 48. Alternatively, two cover plate members can be provided with the mesh material 28 captured therebetween. In the latter alternative version of the top plate, a first food safe gasket 50 may be provided between a first cover plate 30 and a first side of the mesh 28 as well as a second food safe gasket 50 is provided between a second side of the mesh 28 and a second cover plate 30. A large center hole 54 can been seen to permit pass-through access of a winch hook through the cover to communicate with an interior loop 44, 45 to facilitate transport of the main wash basket 10 of the present invention.

Therefore, in general, the cover 30 of FIG. 5 is secured to the top open end of the cylindrical frame 18, with gasket 50 residing therebetween, to provide a horizontal circular plate with holes therethrough to receive bolts 38 to secure the top cover 30 thereto. A bottom cover panel 31 is similarly configured. With the use of the removable fasteners that pass through the top cover 30, the top cover 30 can be quickly separated from the cylindrical frame 18 for easy repair. It is also possible to provide studs welded on to the bezels so the system can be used with bolts/nuts or studs/nuts.

Thus, each of the side panels 22a-d, top cover 30 and bottom cover 31 can each be selectively removed individually and replaced with a single panel to replace a single damaged panel without having to send out the entire basket 10 out for repair which would render the entire wash basket 10 unusable while being repaired. On other hand, with the present invention, single panel 22a, 22b, 22c, or 22d can be replaced immediately so the main wash basket 10 can immediately resume being used where the single panel 22a, 22b, 22c, or 22d can be repaired later thereby avoiding any downtime for the main wash basket 10.

Turning now to FIGS. 6-10, details of the lay-up of the side panels 22a-d which are releasable connected to the frame 18 of the main wash basket 10. In FIG. 12, the basket frame 18 is shown with three quarter panels 22b, 22c, 22d attached thereto. The front-most panel 22a is removed for illustration purposes and is shown in FIGS. 6-10. As can be seen, the holes 20 on the frame in FIG. 12 match up with the holes through the side panel 22a of FIGS. 6-10. FIG. 12 also shows the use of agitating paddles 56 that are secured to the center rotating stem 24.

The agitating paddles 56 can also be seen in FIG. 11 and are preferably horizontally oriented “finger-like” members. Other shapes and sizes of agitating paddles 56 are envisioned and possible in accordance with the present invention are to “roll” and/or “flip” the cannabis material 14 inside the basket 10. It should be understood that many different of such types of paddles 56 can be used according to the cannabis material 14 being processed, for example. The paddles 56 are preferably removable for easy and quick repair. As can be seen in FIGS. 11 and 12 the paddles 56 are secured by releasable fasteners 58 so any one or more of paddles 56, if damaged, can be removed and replaced quickly.

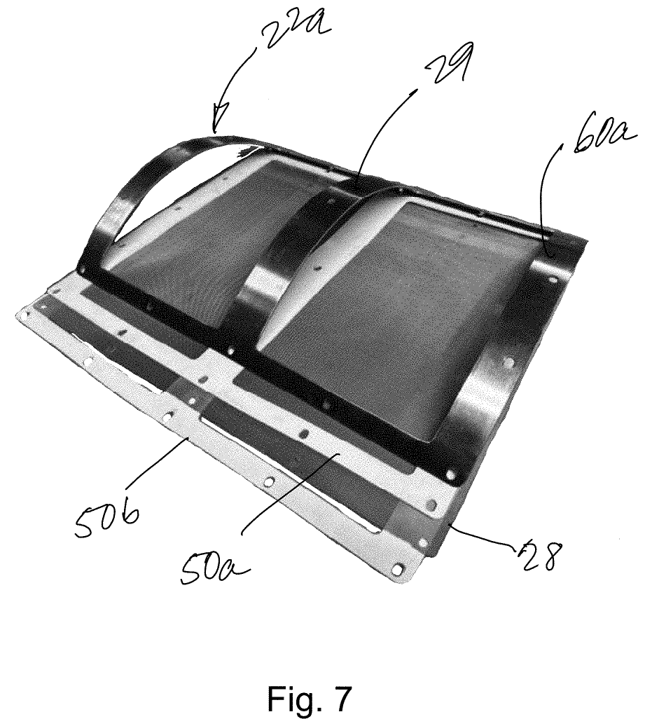

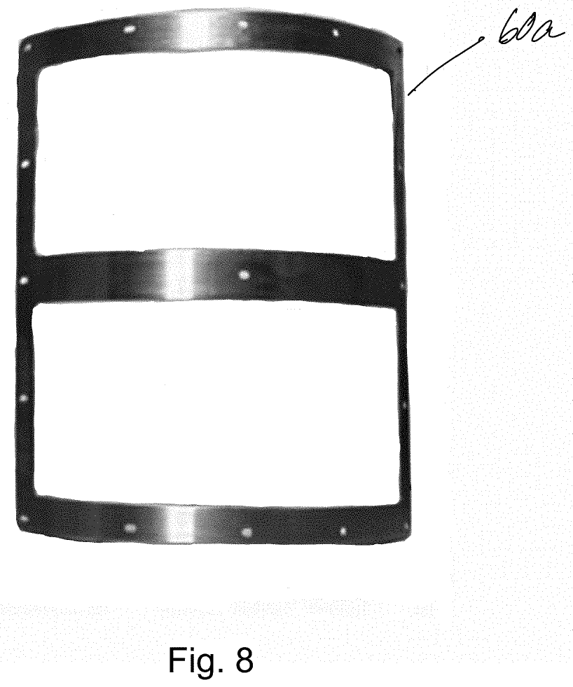

Referring now to FIG. 6, lay-up of the materials for the construction of the side panels 22a-d are shown. As can be seen, various layers of material are stacked on each other to provide the side panel construction. FIG. 6 shows an interior concave face 23 of the side panel, for example panel 22a, that faces in toward the frame. In FIG. 6, each of the materials are stacked on top of each other. FIG. 7 shows an exterior convex face 29 of the side panel 22a with the lay-up of materials exploded for illustration purposes. Each side panel 22a-d has a respective bezel member 60a-d, as shown alone in FIG. 8, which is preferably made of 12 gauge stainless steel but could be made of any other material, such as other metal or non-metal materials. Each of the bezels 60a-d are preferably cut into four quarter round panels to encircle 360 degrees about the substantially cylindrical frame 18. The frame and the panels could be other shapes but cylindrical is preferred. While four quarter panels 22a-d are preferred, other configurations are envisioned and within the scope of the present invention, such as two half panels of 180 degrees each, eight panels of 45 degrees each, and the like. The bezels 60a-d are rolled to match the curvature of the underlying basket frame 18.

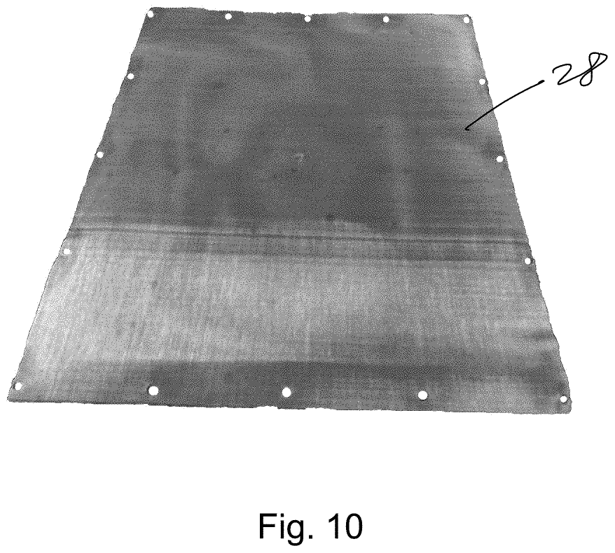

A mesh layer 28, as shown alone in FIG. 10, is provided between the bezel 60a and the frame 18. The mesh layer 28/is preferably 220 micron but any size mesh can be used. The mesh 28 is preferably stainless steel mesh but could be made of other metals or any other material. The mesh 28 is cut out as complete panels, as seen in FIG. 10, so one size of particulate can filtered with such selected size of the mesh material 28. It should be understood that different main wash baskets can be equipped with different sized mesh material 28 to achieve the desired cannabis filtration of trichomes therefrom in view of the strain, type and condition of the cannabis loaded into and processed by the main wash basket 10 of the present invention.

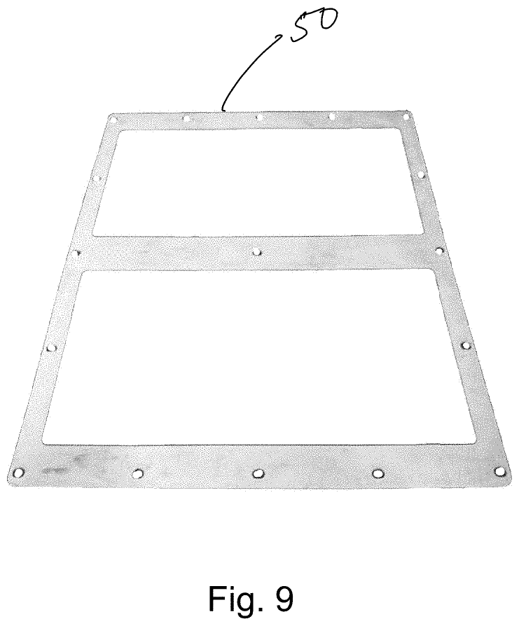

A first food grade gasket 50a is provided between the mesh layer 28 and the bezel 60a as well as a second food grade gasket 50b provided between the mesh layer 28 and then main basket frame 18. Thus, two gaskets 50a, b are used for each side panel 22a-d, for a preferred total of eight gaskets, generally referred to as 50. A food grade gasket 50a is shown alone in FIG. 9. The food grade baskets 50a, 50b for each side panel 22a-d, preferably have the same size and configuration of the bezel 60a to provide the desired sandwiching of the different layers. The gaskets 50a, 50b enables the mesh 28 to be squeezed with sufficient force to provide a good seal between the bezel 60a and the frame 18 of the basket 10 to avoid undesirable leaks.

Thus, the mesh layer 28 is bounded on both of its side by a gasket layer 50a, 50b. Referring back to FIG. 6, each of the above-noted layers of bezel 60a, mesh 28 and two gaskets 50a, 50b are stacked and aligned and then the stacked lay-up of materials layers are fastened, namely by threaded bolts 26, or the like, to the side of the frame member 18, namely to a quarter (90 degree) portion of the frame 18. In other words, the laid-up side panel of 22a is fastened to the frame 18, namely, in the free space at the front of the main wash basket 10 that is devoid of side panel.

This is an example of the use of the present invention where the side panel 22a-d of FIG. 6 is removed from the main wash basket 10 of FIG. 12 thereby leaving a space for one side panel 22a, 22b, 22c or 22d. A replacement panel 22a, 22b, 22c or 22d can be immediately be attached to the frame 18 in FIG. 12 to complete the main wash basket 10 for immediate use without having to wait for the repair of an individual panel 22a, 22b, 22c or 22d that is damaged.

Referring again to FIG. 11, all of the side panels 22a-d are shown installed in place to the frame 18. The transverse rods 27 assist in retaining the general cylindrical shape of the frame 18 and providing rigidity of the overall wash basket 10 structure. FIG. 11 also illustrates the various fasteners 26 that pass through the side panels 22a-d and through the frame 18 to selectively secure the side panels 22a-d in place. As stated above, this allows for quick, simple and easy removal of a damaged mesh 28 of a single panel 22a, 22b, 22c or 22d that may have been cut or punctured and, as a result, unable to function properly. Therefore, only that damaged panel (mesh portion 28 for example) for focused and isolated repair of that single component to avoid repair and downtime of the entire main wash basket 10.

It would be appreciated by those skilled in the art that various changes and modifications can be made to the illustrated embodiments without departing from the spirit of the present invention. All such modifications and changes are intended to be covered by the appended claims.

What is claimed is:

1. An easily repairable wash basket for use in a main washing vessel for washing cannabis trichomes from cannabis plants, comprising:
a frame having a plurality of windows and holes and a top open end;
a side panel having a bezel and filter mesh attached thereto;
the side panel being removably attached to the frame to cover one of the windows of the frame with fasteners secured through the holes;
wherein the side panels and the top panel being selectively removable from the cylindrical frame to facilitate repair of one or more of the side panels and the top panel.

2. The easily repairable wash basket of claim 1, further comprising:
a first gasket residing between the bezel and the filter mesh;
a second gasket residing between the mesh and the frame.

3. The easily repairable wash basket of claim 2, wherein the first gasket and second gasket are made of a food safe sealant or food safe gasket material.

4. The easily repairable wash basket of claim 1, wherein a plurality of side panels are secured to the frame to cover the entire side surface of the frame.

5. The easily repairable wash basket of claim 1, wherein the frame is cylindrical.

6. The easily repairable wash basket of claim 1, further comprising:
a top panel having a bezel and filter mesh attached thereto;
the top panel being removably attached to the top open end of the cylindrical frame.

7. The easily repairable wash basket of claim 1, further comprising:
a bottom panel having a bezel and filter mesh attached thereto.

8. The easily repairable wash basket of claim 7, further comprising:
a stem attached to the bottom panel.

9. The easily repairable wash basket of claim 8, further comprising:
at least one paddle attached to the stem.

10. The easily repairable wash basket of claim 1, wherein the fasteners are threaded bolts.
